(19) United States
(12) Patent Application Publication
(10) Pub. No.: US 2025/0340439 A1
(43) Pub. Date: Nov. 6, 2025

(54) EDGE FUNCTIONALISED GRAPHENE THERMAL NANOFLUIDS

(71) Applicant: Sicona Battery Technologies Pty Ltd,, North Wollongong, New South Wales (AU)

(72) Inventor: Gregory Michael Ryder, Sydney, New South Wales (AU)

(21) Appl. No.: 18/723,782

(22) PCT Filed: Dec. 22, 2022
(86) PCT No.: PCT/AU2022/051569

§ 371 Date: Jun. 24, 2024

(30) Foreign Application Priority Data
Dec. 23, 2021 (AU) 2021904251

(51) Int. Cl. C01B 32/194; C09K 5/10

(52) U.S. Cl. CPC C01B 32/194; B82Y 30/00; C09K 5/10; C01B 2204/04; C01B 2204/22; C01P 2002/72; C01P 2002/82; C01P 2002/85; C01P 2004/03; C01P 2004/04; C01P 2006/22

(57) ABSTRACT

The present disclosure provides a composition for use as a thermal fluid, the composition comprising an amount of a dispersible graphene platelet including a base layer of graphene; at least one discontinuous graphene layer stacked on the base layer; wherein the at least one discontinuous layer has a smaller surface area than the base layer; and wherein the edge regions of the base layer and the at least one discontinuous layer are at least partially functionalised; and a dispersion medium comprising an amount of water.

### RELATED APPLICATION

The present application claims convention priority to Australian Provisional Patent Application 2021904251, filed on 23 Dec. 2021. The content of AU′251 is incorporated by reference herein in its entirety.

### FIELD OF THE INVENTION

The present disclosure relates to uses of Applicant's novel edge functionalised graphene, and more particularly, its use as a thermal fluid for cooling server farms and the like.

Although the present invention will be described hereinafter with reference to its preferred embodiment, it will be appreciated by those of skill in the art that the spirit and scope of the invention may be embodied in many other forms.

### BACKGROUND OF THE INVENTION

Any discussion of the prior art throughout the specification should in no way be considered as an admission that such prior art is widely known or forms part of common general knowledge in the field.

Novel edge functionalised graphene is described in PCT/AU2019/051076 and related national phase applications, each now assigned to the present Applicant.

PCT/AU2019/051076 teaches a dispersible graphene platelet and a method of making same. The structure of the graphene platelet comprises a base layer of graphene on which at least one discontinuous layer of graphene is stacked, with each layer of graphene above the base layer having a smaller surface area than the layer it is stacked upon. The edges of the base layer and the discontinuous layers stacked upon it are all at least partially functionalised, providing a structure with graphene-like properties owing to the base layer and relatively high dispersibility owing to the increased amount of functionalised groups on each platelet. Amongst other uses, the platelets were envisaged to have utility in the production of electrodes or composite materials.

In general terms, graphene, a carbon film one atomic layer thick, has a number of desirable properties such as high thermal and electrical conductivity as well as high mechanical strength. Accordingly, graphene is a promising material for a wide range of applications such as energy storage, biological sensing, and filtration, as well as improved electrical and medical devices. Currently though, use of graphene in these applications is limited by the difficulty in producing and storing large quantities of graphene or graphene derivatives such as nanoplatelets or nanoribbons for industrial scale manufacture while maintaining the desired properties of graphene. The term graphene is commonly accepted to refer to carbon films (and associated materials) between one and ten atomic layers thick. It will thus be understood that throughout this specification, that graphene refers to carbon films of up to ten atomic layers. Carbon films with more than ten atomic layers are typically referred to as graphite.

Since graphene was first isolated by mechanical cleavage through the “Scotch tape” method where adhesive tape was used to strip layers of graphene off bulk graphite, numerous processing routes such as chemical vapour deposition and ball milling have been investigated with the aim of providing an efficient method to produce industrial scale quantities of graphene, but currently, few have proved viable.

The Hummer method, developed in the 1950s to produce graphite oxide, has been modified to enable the production of large quantities of graphene oxide. Attempts have been made to convert graphene oxide to graphene by reduction. Currently however, graphene oxide has not been successfully reduced to graphene, such that while large quantities can be produced, they have sub-optimal properties compared to native graphene.

One production route that has shown promise is liquid-phase exfoliation. In this method, graphite is exfoliated into graphene in a liquid media, often by use of an ultrasonication. As the layers of graphene are held together by weak van der Waals forces, ultrasonic waves are able to break apart layers of graphene. This can further be improved by altering the composition of the liquid media to include solvents or stabilisers to decrease the potential energy barrier between the sheets.

An issue with graphene produced by liquid-phase exfoliation is large amounts of solvents are required, owing to the poor dispersibility of graphene structures. For instance, pure graphene can only be dispersed in pure water at concentrations below 0.01 g/L and this limit is not greatly improved by the addition of surfactants or by constant agitation. Above these concentrations, graphene tends to agglomerate, restacking into graphite structures. Accordingly, it is unfeasible to store graphene for long periods of time as large amounts of solvents are required. Thus, a form of graphene allowing for a higher stable dispersion in water while retaining the beneficial properties of graphene such as electrical conductivity is desired.

The tendency of graphene structures to agglomerate also poses a challenge in using graphene structures in composite materials. In many cases, it is preferable to have a homogenous distribution of a dispersed phase, such as graphene, within the matrix of another material, for instance a polymer, to improve the matrix material's properties such as strength and electrical conductivity. A stable dispersion of graphene structures would enable easier fabrication of graphene composites with higher concentrations of the dispersed phase, allowing greater tailoring of the composite's material properties.

A means of increasing the dispersity of graphene structures is by functionalising the edges of the graphene sheets. This allows the structure to substantially retain the properties of native graphene while increasing the dispersity. These structures are often referred to as edge functionalised graphene, as described above.

Aside from the method described by Applicant in PCT/AU2019/051076, another method for producing edge functionalised graphene was described by Ding et al. Sci. Rep. 8:5567 (2018). This method comprises adding graphite powder to degassed water, sonicating the mixture to produce a black graphite slurry, vapour exfoliating the slurry by mechanical stirring at heat to functionalise the edges of the platelets, and cooling, diluting and sonicating the resultant mixture to purify it. This produced nanoplatelets a few layers thick with hydroxyl groups at the edges. These edge groups allow the platelets to be dispersed in water at concentrations up to 0.55 g/mL. While this represents an improvement in the dispersibility of graphene structures, large amounts of solvent are still required. Accordingly, a graphene structure with greater dispersibility was duly taught by Applicant in PCT/AU2019/051076.

A thermal fluid is a gas or liquid that facilitates thermal conductivity by serving as an intermediary in cooling on one side of a process, transporting and storing thermal energy, and heating on another side of a process. Thermal fluids are used in countless applications and industrial processes requiring heating or cooling, typically in a closed circuit and in continuous cycles. Cooling water for instance cools an engine, while heating water in a hydronic heating system heats the radiator in a room. Water is the most common thermal fluid because of its economy, high heat capacity and favorable transport properties. However, the useful temperature range is restricted by freezing below 0° C. and boiling at elevated temperatures depending on the system pressure. Antifreeze additives can alleviate the freezing problem to some extent. However, many other thermal fluids have been developed and used in a huge variety of applications.

For higher temperatures, oil or synthetic hydrocarbon or silicone based fluids offer lower vapor pressure. Molten salts and molten metals can be used for transferring and storing heat at temperatures above 300 to 400° C. where organic fluids start to decompose. Gases such as water vapor, nitrogen, argon, helium and hydrogen have been used as thermal fluids where liquids are not suitable. For gases the pressure typically needs to be elevated to facilitate higher flow rates with low pumping power.

A server farm represents a modern day challenge for thermal fluids. A server farm is a collection of computer servers usually maintained by an organisation to supply server functionality far beyond the capability of a single machine. Server farms often consist of many thousands of computers which require a large amount of power to run and generate a large amount of heat, which also then requires a large amount of to keep the server farm cool so as to maintain efficiency. Server farmers typically mount the computers, routers, power supplies, and related electronics on 19-inch racks in a server room or data centre. Because space is at a premium, it follows that the server racks should be housed as closely as possible. However, this gives rise to significant air flow, heating and cooling issues.

While the performance of servers is improving, the power consumption of servers is also rising despite efforts in low power design of integrated circuits. For example, one of the most widely used server processors runs at up to 95 watts. Another server processor runs at between 110 and 165 watts. Processors are only part of a server, however; other parts in a server such as storage devices consume additional power and all parts contribute to the overall heat generation.

A data centre room should be maintained at acceptable temperatures and humidity for reliable operation of the servers, especially for fanless servers. The power consumption of a rack densely stacked with servers powered by modern processors may be between 7000 and 15,000 watts. As a result, server racks can produce very concentrated heat loads. The heat dissipated by the servers in the racks is exhausted to the data centre room. The heat collectively generated by densely populated racks can have an adverse effect on the performance and reliability of the equipment in the racks, since they rely on the surrounding air for cooling. Accordingly, heating, ventilation, air conditioning (HVAC) systems are often an important part of the design of an efficient data centre.

In a data centre room, server racks are typically laid out in rows with alternating cold and hot aisles between them. All servers are installed into the racks to achieve a front-to-back airflow pattern that draws conditioned air in from the cold rows, located in front of the rack, and ejects heat out through the hot rows behind the racks. A raised floor room design is commonly used to accommodate an underfloor air distribution system, where cooled air is supplied through vents in the raised floor along the cold aisles.

An important factor in efficient cooling of data centre is to manage the air flow and circulation inside a data centre. Computer Room Air Conditioners (CRAC) units supply cold air through floor tiles including vents between the racks. In addition to servers, CRAC units consume significant amounts of power as well. One CRAC unit may have up to three 5 horsepower motors and up to 150 CRAC units may be needed to cool a data centre. The CRAC units collectively consume significant amounts of power in a data centre. For example, in a data centre room with hot and cold row configuration, hot air from the hot rows is moved out of the hot row and circulated to the CRAC units. The CRAC units cool the air. Fans powered by the motors of the CRAC units supply the cooled air to an underfloor plenum defined by the raised sub-floor. The pressure created by driving the cooled air into the underfloor plenum drives the cooled air upwardly through vents in the subfloor, supplying it to the cold aisles where the server racks are facing. To achieve a sufficient air flow rate, hundreds of powerful CRAC units may be installed throughout a typical data centre room. However, since CRAC units are generally installed at the corners of the data centre room, their ability to efficiently increase air flow rate is negatively impacted. The cost of building a raised floor generally is high and the cooling efficiency generally is low due to inefficient air movement inside the data centre room. In addition, the location of the floor vents requires careful planning throughout the design and construction of the data centre to prevent short circuiting of supply air.

It is an object of the present invention to overcome or ameliorate at least one of the disadvantages of the prior art, or to provide a useful alternative.

It is an object of an especially preferred form of the present invention to provide a composition suitable for use as a thermal fluid for use in cooling, for instance, a data centre, a radiator or an air conditioner. Due to the cost and favourable thermal profile of water, it is envisaged that water should comprise the primary component of the composition.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

The present inventors have surprisingly discovered that edge functionalised graphene, of the type described in PCT/AU2019/051076, forms an efficient thermal fluid when combined with water or water-glycol in an amount of between about 0.25 and 1.0 wt. %. It is surprisingly found that this combination of features is effective to significantly reduce the energy required to cool the composition and to increase the efficiency in which the composition transports heat.

It is found that the use of edge functionalised graphene increases the permeability of heat into the composition. The edge functionalised graphene enables it to hydrogen bond with the surrounding water molecules forming a substantially homogeneous solution. Such a solution can transport heat more effectively, which in turn increases the amount of heat the solution can absorb in a reduced timeframe and reduces the energy required to remove heat from the solution when required.

The amount of edge functionalised graphene required to induce an effect can be as little as 0.01% by weight but its effects plateau after ˜5-6 wt. %. The ideal range is found to be between 0.25-1% by weight.

It is further found that increased concentrations of edge functionalised graphene may increase the viscosity of the composition, although not to an extent that stands to impact its use in most, if not all, coolant systems.

The edge functionalised graphene mixture, when used in a cooling system, may reduce the energy use by up to 50%. In its appropriate commercial context, even a 2% efficiency increase could be a potential game-changer.

The composition may include other components, such as propylene glycol, ethylene glygol, ethanol, methanol, propanol, etc. These can be present in any mixture from about 0.01 wt. % to 50 wt. %, preferably up to 30 wt. %. Other components may include alcohols, surfactants, dyes, or mild acids or bases. The purpose of the other components are to increase the boiling point elevation, decrease the freezing point depression, make the mixture readily identifiable in cases of leakage, or to solubilise/make salts out of any of the components.

Finally, although edge functionalised graphene is stable in solution, surfactants/stabilisers may aid with the stability, especially over time.

According to a first aspect of the present invention there is provided a composition for use as a thermal fluid, the composition comprising:
a) an amount of a dispersible graphene platelet including a base layer of graphene; at least one discontinuous graphene layer stacked on the base layer; wherein the at least one discontinuous layer has a smaller surface area than the base layer; and wherein the edge regions of the base layer and the at least one discontinuous layer are at least partially functionalised; and
b) a dispersion medium comprising an amount of water.

In an embodiment, the dispersible graphene platelet comprises defined central and edge regions, wherein the edge region is at least partially functionalised, and central region at least partially unfunctionalised.

In an embodiment, the amount of the dispersible graphene platelet is between about 0.1 and about 6 wt % of the composition.

In an embodiment, the amount of the dispersible graphene platelet is about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, or about 6 wt % of the composition.

In an embodiment, the water can be any desired amount, preferably from 1 to 99% by weight, which includes all values and subranges therebetween, including 1, 2, 3, 4, 5, 6, 7, 8, 9, 10, 15, 20, 25, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62. 63, 64, 65, 66, 67, 68, 69, 70, 71, 72, 73, 74, 75, 76, 77, 78, 79, 80, 85, 90, 95, 96, 97, 98, 99% by weight, based on the total weight of the composition. More preferably, the amount of water is in the range from 94 to 99.9% by weight, most preferably from 99 to 99.9% by weight. The water is preferably distilled and/or deionised. Preferably, the water is deionised before contacting with the other components of the composition.

In an embodiment, the amount of the dispersible graphene platelet is between about 0.1 and about 1 wt % of the composition.

In an embodiment, the amount of the dispersible graphene platelet is between about 0.2 and about 0.9 wt %, between about 0.3 and about 0.8 wt. %, between about 0.4 and about 0.7 wt. %, or between about 0.5 and about 0.6 wt. % of the composition.

In an embodiment, the amount of the dispersible graphene platelet is between about 0.25 and about 1 wt % of the composition.

In an embodiment, the dispersion medium further comprises one or more co-solvents.

In an embodiment, the one or more co-solvents is selected from a glycol, such as ethylene glycol, propylene glycol, 1,3-butylene glycol, hexylene glycol, diethylene glycol, di-propylene glycol or glycerin, among which ethylene glycol and propylene glycol are preferred for their chemical stability and low cost.

In an embodiment, the one or more co-solvents can be glymes, di-glymes and the like, which may elicit a similar effect to a glycol.

In an embodiment, the one or more co-solvents is selected from hexanoic acid, heptanoic acid and their salts and at least one ingredient selected from among alkylbenzoic acids having C₁-C₅ alkyl and their salts. Hexanoic acid, heptanoic acid and their salts individually have an excellent aluminium and iron corrosion inhibitory properties, and in cooperation with at least one ingredient selected from the group of alkylbenzoic acids having C₁-C₅ alkyl and their salts can excellently inhibit cavitation in a cooling system.

In an embodiment, the salts of hexanoic acid and heptanoic acid may be their alkali metal salts, ammonium salts or amine salts, among which alkali metal salts are preferred. Preferred alkali metal salts are sodium salts and potassium salts. A plurality of these chemicals may be blended in the composition of the present invention.

In an embodiment, the hexanoic acid, heptanoic acid and/or their salt or salts are blended in the composition of the present invention in a total amount of about 0.1-5.0% by weight. Less than that range will prove insufficient in prohibition of metal corrosion and cavitation while more than that range may be uneconomical.

In an embodiment, the alkylbenzoic acids having C₁-C₅ alkyl and their salts can individually inhibit metal corrosion, particularly aluminium and iron corrosion, as well as inhibit cavitation in a cooling system in cooperation with hexanoic acid, heptanoic acid and/or their salt or salts. In addition, they can individually inhibit precipitation with hard water minerals in the cooling liquid.

In an embodiment, the alkylbenzoic acids having C₁-C₅ alkyl may be p-toluic acid, p-ethylbenzoic acid, p-propylbenzoic acid, p-isopropylbenzoic acid, p-butylbenzoic acid or p-tert butylbenzoic acid. The salts of alkylbenzoic acids having C₁-C₅ alkyl may be their alkali metal salts, ammonium salts or amine salts, among which alkali metal salts such as sodium salts and potassium salts are preferred Such salts may be blended in a plurality.

In an embodiment, the alkylbenzoic acids having C₁-C₅ alkyl and/or their salts may be blended singly or in a plurality in the composition of the present invention in a total amount of about 0.1-5.0% by weight. Less than that range will be inefficient in inhibition of metal corrosion and cavitation and over that range may be uneconomical.

In an embodiment, one or more triazoles may be additionally blended, which effectively inhibit corrosion of metals, particularly copper and aluminium in a cooling system. Such triazoles are preferably selected from benzotriazol, tolyltriazol 4-phenyl-1,2,3-triazole and 2-naphthotriazol or 4-nitrobenzotriazol.

In an embodiment, the triazole or triazoles may be blended in an amount of about 0.05-1.0% by weight. Less than that range will be insufficient in inhibition of metal corrosion and more than that range may be uneconomical.

In an embodiment, the composition of the present invention may optionally be characterized by the absence of certain ingredients, namely amine salts or borates.

Generation of nitrosoamine in the cooling liquid will be prevented by the absence of amine salts, while the absence of borates will contribute to lessen corrosion of aluminium and aluminium alloys.

In an embodiment, the composition may optionally and selectively comprise an antifoam and/or colorant and/or a conventional metal corrosion inhibitor or inhibitors such as molybdate, tungstate, sulfate, nitrate, mercaptobenzothiazol, or their alkali metal salts.

In an embodiment, the one or more co-solvents is ethylene glycol or propylene glycol. Preferably, the one or more co-solvents is ethylene glycol.

In an embodiment, the dispersion medium comprises water and the one or more co-solvents in an approximate 50:50 ratio by weight.

In an embodiment, the dispersion medium comprises water and the one or more co-solvents in an approximate 60:40 ratio by weight.

In an embodiment, the dispersion medium comprises water and the one or more co-solvents in an approximate 70:30 ratio by weight.

In an embodiment, the dispersion medium comprises water and the one or more co-solvents in an approximate 80:20 ratio by weight.

In an embodiment, the one or more co-solvents used can be in any desired amount, preferably from 1 to 99% by weight, which includes all values and subranges therebetween, including 1, 2, 3, 4, 5, 6, 7, 8, 9, 10, 15, 20, 25, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62. 63, 64, 65, 66, 67, 68, 69, 70, 71, 72, 73, 74, 75, 76, 77, 78, 79, 80, 85, 90, 95, 96, 97, 98, 99% by weight, based on the total weight of the composition.

In an embodiment, the composition of the present invention further comprises at least one fluorosurfactant in an amount of 0.001 to 50% by weight, which includes all values and subranges therebetween, including 0.002, 0.003, 0.004, 0,005, 0.006, 0.007, 0.008, 0.009, 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. The fluorosurfactant desirably causes a reduction in contact angle (e.g., droplet height) compared to an untreated water/glycol mixture, modifies the surface properties of liquids or solids, or reduces surface tension in a fluid or the interfacial tension between two immiscible fluids, for example oil and water. Preferably, the fluorosurfactant is soluble in water. Preferable fluorosurfactants include, but are not limited to, the Zonyl fluorosurfactants (anionic, nonionic and amphoteric fluorinated surfactants) including, but not limited to Zonyl FSA, FSE, FSJ, FSP, TBS, FSO, FSH, FSN, FSD and FSK, more preferably the non-ionic Zonyl fluorosurfactants, most preferably Zonyl FSH, FSN or FSP (typically mixtures of a fluoroalkyl alcohol substituted polyethylene glycol with water and a glycol or glycol ether such as dipropylene glycol methyl ether). The fluorosurfactant can be used alone, or can be combined with other fluorosurfactants or non-fluorine containing surfactants as desired.

In an embodiment, a defoamer, if present, may be used in an amount sufficient to reduce buildup of foam or reduce foam or trapped air by causing the bubbles to burst, thus releasing the trapped air. Preferably the defoamer is used in an amount of from 0.01 to 50% by weight, which includes all values and subranges therebetween, including 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. One or more than one defoamer may be present. Preferable defoamers include, but are not limited to ethylene glycol n-butyl ether based defoamer, silicone emulsions, hydrocarbon oil emulsions, EO/PO copolymers and oil soluble, water miscible defoamers.

In an embodiment, the composition may comprise one or more corrosion inhibitors, in an amount sufficient to inhibit or reduce corrosion of exposed metal surfaces in contact with the composition of the present invention, preferably in an amount of from 0.01 to 50% by weight, which includes all values and subranges therebetween, including 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. Preferable corrosion inhibitors include any conventionally or commercially used corrosion inhibitor, including, but not limited to, sodium nitrate, sodium nitrite, azonitriles, dipotassium phosphate, sodium benzoate and mixtures thereof, for example. More preferably the corrosion inhibitor is an aqueous solution of nitrites, nitrates and sodium hydroxide.

In an embodiment, the composition may contain a colorant in order to help a user readily distinguish the composition from colorless liquids, particularly from water. Suitable colorants can be any conventional colorant, and can be any desired color, including but not limited to orange, blue, green, red and yellow, and any combination thereof. If present, the dye can be used in any amount to provide the color desired, preferably from 0.01 to 50% by weight, which includes all values and subranges therebetween, including 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. One or more than one dye may be present. More preferably, any light stable, transparent water soluble organic dye is suitable, including but not limited to, acid red dyes, methylene blue, uranine dye, wool yellow dye and rhodamine dye being particularly preferred.

In an embodiment, the pH of the composition may be adjusted as appropriate. Any compound that is pH active is appropriately used, and may be selected according to what is known in the art. The pH may range from 3 to 11, which includes all values and subranges therebetween, including 3.5, 4, 4.5, 5, 5.5, 6, 6.5, 7, 7.5, 8, 8.5, 9, 9.5, 10, 10.5. Aminomethyl propanol is preferable as pH adjuster. Preferably, the pH is adjusted to avoid using any of the reserve alkalinity of the corrosion inhibitor or corrosion inhibitor composition.

In an embodiment, the platelet is able to form a stable dispersion in water at concentrations up to 700 mg/mL.

In an embodiment, the electrical conductivity of the platelet is approximately 900 S/cm.

In an embodiment, the platelet is further functionalised by the addition of metal ions to at least one of the functionalised edges or the surface.

In an embodiment, the metal ions are selected from Fe, Cu, Co, and Sn.

According to a second aspect of the present invention there is provided a composition for use as a thermal fluid, the composition comprising:
a) an amount of a polymer-matrix composite material comprising a polymer and a dispersible graphene platelet including a base layer of graphene; at least one discontinuous graphene layer stacked on the base layer; wherein the at least one discontinuous layer has a smaller surface area than the base layer; and wherein the edge regions of the base layer and the at least one discontinuous layer are at least partially functionalised; and
b) a dispersion medium comprising an amount of water.

In an embodiment, the dispersible graphene platelet comprises defined central and edge regions, wherein the edge region is at least partially functionalised, and central region at least partially unfunctionalised.

In an embodiment, the amount of the dispersible graphene platelet is between about 0.1 and about 6 wt % of the composition.

In an embodiment, the amount of the dispersible graphene platelet is between about 0.25 and about 1 wt % of the composition.

In an embodiment, the dispersion medium further comprises one or more co-solvents.

In an embodiment, the one or more co-solvents is selected from a glycol, such as ethylene glycol, propylene glycol, 1,3-butylene glycol, hexylene glycol, diethylene glycol, di-propylene glycol or glycerin, among which ethylene glycol and propylene glycol are preferred for their chemical stability and low cost.

In an embodiment, the one or more co-solvents is selected from hexanoic acid, heptanoic acid and their salts and at least one ingredient selected from among alkylbenzoic acids having C₁-C₅ alkyl and their salts. Hexanoic acid, heptanoic acid and their salts individually have an excellent aluminium and iron corrosion inhibitory properties, and in cooperation with at least one ingredient selected from the group of alkylbenzoic acids having C₁-C₅ alkyl and their salts can excellently inhibit cavitation in a cooling system.

In an embodiment, the salts of hexanoic acid and heptanoic acid may be their alkali metal salts, ammonium salts or amine salts, among which alkali metal salts are preferred. Preferred alkali metal salts are sodium salts and potassium salts. A plurality of these chemicals may be blended in the composition of the present invention.

In an embodiment, the hexanoic acid, heptanoic acid and/or their salt or salts are blended in the composition of the present invention in a total amount of about 0.1-5.0% by weight. Less than that range will prove insufficient in prohibition of metal corrosion and cavitation while more than that range may be uneconomical.

In an embodiment, the alkylbenzoic acids having C₁-C₅ alkyl and their salts can individually inhibit metal corrosion, particularly aluminium and iron corrosion, as well as inhibit cavitation in a cooling system in cooperation with hexanoic acid, heptanoic acid and/or their salt or salts. In addition, they can individually inhibit precipitation with hard water minerals in the cooling liquid.

In an embodiment, the alkylbenzoic acids having C₁-C₅ alkyl may be p-toluic acid, p-ethylbenzoic acid, p-propylbenzoic acid, p-isopropylbenzoic acid, p-butylbenzoic acid or p-tert butylbenzoic acid. The salts of alkylbenzoic acids having C₁-C₅ alkyl may be their alkali metal salts, ammonium salts or amine salts, among which alkali metal salts such as sodium salts and potassium salts are preferred Such salts may be blended in a plurality.

In an embodiment, the alkylbenzoic acids having C₁-C₅ alkyl and/or their salts may be blended singly or in a plurality in the composition of the present invention in a total amount of about 0.1-5.0% by weight. Less than that range will be inefficient in inhibition of metal corrosion and cavitation and over that range may be uneconomical.

In an embodiment, one or more triazoles may be additionally blended, which effectively inhibit corrosion of metals, particularly copper and aluminium in a cooling system. Such triazoles are preferably selected from benzotriazol, tolyltriazol 4-phenyl-1,2,3-triazole and 2-naphthotriazol or 4-nitrobenzotriazol.

In an embodiment, the triazole or triazoles may be blended in an amount of about 0.05-1.0% by weight. Less than that range will be insufficient in inhibition of metal corrosion and more than that range may be uneconomical.

In an embodiment, the composition of the present invention may optionally be characterized by the absence of certain ingredients, namely amine salts or borates. Generation of nitrosoamine in the cooling liquid will be prevented by the absence of amine salts, while the absence of borates will contribute to lessen corrosion of aluminium and aluminium alloys.

In an embodiment, the composition may optionally and selectively comprise an antifoam and/or colorant and/or a conventional metal corrosion inhibitor or inhibitors such as molybdate, tungstate, sulfate, nitrate, mercaptobenzothiazol, or their alkali metal salts.

In an embodiment, the one or more co-solvents is ethylene glycol or propylene glycol. Preferably, the one or more co-solvents is ethylene glycol.

In an embodiment, the dispersion medium comprises water and the one or more co-solvents in an approximate 50:50 ratio by weight.

In an embodiment, the dispersion medium comprises water and the one or

more co-solvents in an approximate 60:40 ratio by weight.

In an embodiment, the dispersion medium comprises water and the one or more co-solvents in an approximate 70:30 ratio by weight.

In an embodiment, the dispersion medium comprises water and the one or more co-solvents in an approximate 80:20 ratio by weight.

In an embodiment, the one or more co-solvents used can be in any desired amount, preferably from 1 to 99% by weight, which includes all values and subranges therebetween, including 1, 2, 3, 4, 5, 6, 7, 8, 9, 10, 15, 20, 25, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62. 63, 64, 65, 66, 67, 68, 69, 70, 71, 72, 73, 74, 75, 76, 77, 78, 79, 80, 85, 90, 95, 96, 97, 98, 99% by weight, based on the total weight of the composition.

In an embodiment, the composition of the present invention further comprises at least one fluorosurfactant in an amount of 0.001 to 50% by weight, which includes all values and subranges therebetween, including 0.002, 0.003, 0.004, 0,005, 0.006, 0.007, 0.008, 0.009, 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. The fluorosurfactant desirably causes a reduction in contact angle (e.g., droplet height) compared to an untreated water/glycol mixture, modifies the surface properties of liquids or solids, or reduces surface tension in a fluid or the interfacial tension between two immiscible fluids, for example oil and water. Preferably, the fluorosurfactant is soluble in water. Preferable fluorosurfactants include, but are not limited to, the Zonyl fluorosurfactants (anionic, nonionic and amphoteric fluorinated surfactants) including, but not limited to Zonyl FSA, FSE, FSJ, FSP, TBS, FSO, FSH, FSN, FSD and FSK, more preferably the non-ionic Zonyl fluorosurfactants, most preferably Zonyl FSH, FSN or FSP (typically mixtures of a fluoroalkyl alcohol substituted polyethylene glycol with water and a glycol or glycol ether such as dipropylene glycol methyl ether). The fluorosurfactant can be used alone, or can be combined with other fluorosurfactants or non-fluorine containing surfactants as desired.

In an embodiment, a defoamer, if present, may be used in an amount sufficient to reduce buildup of foam or reduce foam or trapped air by causing the bubbles to burst, thus releasing the trapped air. Preferably the defoamer is used in an amount of from 0.01 to 50% by weight, which includes all values and subranges therebetween, including 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. One or more than one defoamer may be present. Preferable defoamers include, but are not limited to ethylene glycol n-butyl ether based defoamer, silicone emulsions, hydrocarbon oil emulsions, EO/PO copolymers and oil soluble, water miscible defoamers.

In an embodiment, the composition may comprise one or more corrosion inhibitors, in an amount sufficient to inhibit or reduce corrosion of exposed metal surfaces in contact with the composition of the present invention, preferably in an amount of from 0.01 to 50% by weight, which includes all values and subranges therebetween, including 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. Preferable corrosion inhibitors include any conventionally or commercially used corrosion inhibitor, including, but not limited to, sodium nitrate, sodium nitrite, azonitriles, dipotassium phosphate, sodium benzoate and mixtures thereof, for example. More preferably the corrosion inhibitor is an aqueous solution of nitrites, nitrates and sodium hydroxide.

In an embodiment, the composition may contain a colorant in order to help a user readily distinguish the composition from colorless liquids, particularly from water. Suitable colorants can be any conventional colorant, and can be any desired color, including but not limited to orange, blue, green, red and yellow, and any combination thereof. If present, the dye can be used in any amount to provide the color desired, preferably from 0.01 to 50% by weight, which includes all values and subranges therebetween, including 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. One or more than one dye may be present. More preferably, any light stable, transparent water soluble organic dye is suitable, including but not limited to, acid red dyes, methylene blue, uranine dye, wool yellow dye and rhodamine dye being particularly preferred.

In an embodiment, the pH of the composition may be adjusted as appropriate. Any compound that is pH active is appropriately used, and may be selected according to what is known in the art. The pH may range from 3 to 11, which includes all values and subranges therebetween, including 3.5, 4, 4.5, 5, 5.5, 6, 6.5, 7, 7.5, 8, 8.5, 9, 9.5, 10, 10.5. Aminomethyl propanol is preferable as pH adjuster. Preferably, the pH is adjusted to avoid using any of the reserve alkalinity of the corrosion inhibitor or corrosion inhibitor composition.

In an embodiment, the platelet is able to form a stable dispersion in water at concentrations up to 700 mg/mL.

In an embodiment, the electrical conductivity of the platelet is approximately 900 S/cm.

In an embodiment, the platelet is further functionalised by the addition of metal ions to at least one of the functionalised edges or the surface.

In an embodiment, the metal ions are selected from Fe, Cu, Co, and Sn.

In an embodiment, the platelet is able to form a stable dispersion in water at concentrations up to 700 mg/mL.

In an embodiment, the electrical conductivity of the platelet is approximately 900 S/cm.

In an embodiment, the platelet is further functionalised by the addition of metal ions to at least one of the functionalised edges or the surface.

In an embodiment, the metal ions are selected from Fe, Cu, Co, and Sn.

In an embodiment, the polymer is selected from alginate, chitosan, PVA, PEG, PU, PEI, PVDF, PDMS or PEDOT PSS.

According to a third aspect of the present invention there is provided a method for producing a composition for use as a thermal fluid, the method comprising the steps of:
a) forming an amount of a dispersible graphene platelet including a base layer of graphene; at least one discontinuous graphene layer stacked on the base layer; wherein the at least one discontinuous layer has a smaller surface area than the base layer; and wherein the edge regions of the base layer and the at least one discontinuous layer are at least partially functionalised by suspending graphite or graphene in a solution containing an organic nitrile (such as acetonitrile), an ester (such as ethyl acetate) and water; and reacting the solution containing suspended graphite or graphene with an oxidant (such as ruthenium tetroxide) to at least partially functionalise edge regions of the graphite or graphene;
b) forming a dispersion medium comprising an amount of water;
c) mixing the amount of the dispersible graphene platelet with the amount of water, thereby to create a substantially homogeneous composition.

In an embodiment, the method further comprises the step of homogenising the resultant solution to ensure substantially regular distribution of the dispersible graphene platelets throughout.

In an embodiment, the method further comprises the step of cooling the resultant solution obtained in step b. in an ice bath.

In an embodiment, the method further comprises the step of homogenising the resultant solution obtained in step b.

In an embodiment, the homogenisation is conducted at 20000 rpm up to 2 hours.

In an embodiment, the method further comprises the step of ultrasonicating the resultant solution obtained in step b.

In an embodiment, the method further comprises the step of filtering the resultant solution obtained in step b to produce a filtered solid.

In an embodiment, the method further comprises the step of washing the filtered solid.

In an embodiment, the method further comprises washing includes washing the filtered solid with HCl and water.

In an embodiment, the filtered solid is washed with HCl until a filtrate produced by washing the filtered solid is colourless and then with water until the filtrate is neutral.

In an embodiment, the filtered solid is washed with an organic solvent such as ethanol or acetone.

In an embodiment, the filtered solid is dried in vacuo to produce a dried powder.

In an embodiment, the filtered solid is freeze dried to produce a dried powder.

In an embodiment, the dried powder is dispersed in water and sonicated for up to 30 minutes, and a resulting mixture is allowed to settle for up to 48 hours to produce a solid and a supernatant, and decanting and filtering the supernatant to produce a graphene powder.

In an embodiment, the graphene powder is washed with an organic solvent and dried.

In an embodiment, the dried powder is dispersed in water and sonicated for up to 30 minutes, and a resulting mixture is centrifuged to produce a solid and a supernatant.

In an embodiment, the oxidant is ruthenium tetroxide.

In an embodiment, the ruthenium tetroxide is provided via the reaction of sodium periodate with ruthenium chloride added to the solution containing suspended graphene or graphite.

In an embodiment, the graphene or graphite is provided in the form of expanded graphite with an increased interlayer spacing.

In an embodiment, the filtered solid is then dispersed in a solution containing metal ions to bind metal ions to at least one of a surface or a functionalised edge of the platelet.

In an embodiment, the metal ions are selected from Fe, Cu, Co, and Sn.

According to a fourth aspect of the present invention there is provided a method for producing a composition for use as a thermal fluid, the method comprising the steps of:
a) forming an amount of a polymer-matrix composite material comprising a polymer and a dispersible graphene platelet including a base layer of graphene; at least one discontinuous graphene layer stacked on the base layer; wherein the at least one discontinuous layer has a smaller surface area than the base layer; and wherein the edge regions of the base layer and the at least one discontinuous layer are at least partially functionalised; and
b) forming a dispersion medium comprising an amount of water; and
c) mixing the amount of the dispersible graphene platelet with the amount of water, thereby to create a substantially homogeneous composition.

In an embodiment, the method further comprises the step of homogenising the resultant solution to ensure substantially regular distribution of the dispersible graphene platelets throughout.

In an embodiment, the method further comprises the step of cooling the resultant solution obtained in step b. in an ice bath.

In an embodiment, the method further comprises the step of homogenising the resultant solution obtained in step b.

In an embodiment, the homogenisation is conducted at 20000 rpm up to 2 hours.

In an embodiment, the method further comprises the step of ultrasonicating the resultant solution obtained in step b.

In an embodiment, the method further comprises the step of filtering the resultant solution obtained in step b to produce a filtered solid.

In an embodiment, the method further comprises the step of washing the filtered solid.

In an embodiment, the method further comprises washing includes washing the filtered solid with HCl and water.

In an embodiment, the filtered solid is washed with HCl until a filtrate produced by washing the filtered solid is colourless and then with water until the filtrate is neutral.

In an embodiment, the filtered solid is washed with an organic solvent such as ethanol or acetone.

In an embodiment, the filtered solid is dried in vacuo to produce a dried powder.

In an embodiment, the filtered solid is freeze dried to produce a dried powder.

In an embodiment, the dried powder is dispersed in water and sonicated for up to 30 minutes, and a resulting mixture is allowed to settle for up to 48 hours to produce a solid and a supernatant, and decanting and filtering the supernatant to produce a graphene powder.

In an embodiment, the graphene powder is washed with an organic solvent and dried.

In an embodiment, the dried powder is dispersed in water and sonicated for up to 30 minutes, and a resulting mixture is centrifuged to produce a solid and a supernatant.

In an embodiment, the oxidant is ruthenium tetroxide.

In an embodiment, the ruthenium tetroxide is provided via the reaction of sodium periodate with ruthenium chloride added to the solution containing suspended graphene or graphite.

In an embodiment, the graphene or graphite is provided in the form of expanded graphite with an increased interlayer spacing.

In an embodiment, the filtered solid is then dispersed in a solution containing metal ions to bind metal ions to at least one of a surface or a functionalised edge of the platelet.

In an embodiment, the metal ions are selected from Fe, Cu, Co, and Sn.

According to a fifth aspect of the present invention there is provided a composition according to the first aspect of the invention, when produced by a method according to the third aspect of the invention.

According to a sixth aspect of the present invention there is provided a composition according to the second aspect of the invention, when produced by a method according to the fourth aspect of the invention.

### BRIEF DESCRIPTION OF THE FIGURES

A preferred embodiment of the present invention will now be described having regard to the following representative and non-limiting figures.

FIG. 1 shows a schematic representation of a dispersible graphene platelet.

FIG. 2 shows a low magnification bright field TEM image of a single dispersible graphene platelet.

FIG. 3 shows a high magnification bright field TEM image of the edge of a dispersible graphene platelet.

FIG. 4 shows an SEM image of a dispersible graphene platelet at 5000× magnification.

FIG. 5A shows a Raman spectrum for a sample of graphene platelets.

FIG. 5B shows a Raman spectrum for 99.9999% graphite.

FIG. 6A shows an expanded 2D band from the Raman spectrum of the edges of a dispersible graphene platelet.

FIG. 6B shows an expanded 2D band from the Raman spectrum of the basal plane of a dispersible graphene platelet.

FIG. 7A shows the XRD spectrum for a sample of graphene platelets.

FIG. 7B shows the XRD spectrum for both 99.9999% graphite and graphene platelets.

FIG. 8 shows an XPS spectrum for a sample of graphene platelets.

FIG. 9 shows a graph of the titration of a dispersion of the graphene platelets.

FIG. 10 shows TEM images of EFG at low and high magnifications. a) Several EFG NPs are visible in the image. b) A bright field image of a typical EFG NP. c) and d) High resolution images of the edge of a typical sheet confirming the presence of 1-4 layers. Note the edge of the EFG in c) which shows a monolayer, while in d) 2 layers can be seen. e) Bright field (BF) image and f) annular dark-field image (HAADF) of a typical EFG platelet at the edge. (i), (ii) and (iii) show mono, double and three layers are, respectively, while (iv) represents an oxygen rich area on the edge. From (i) to (iii) the diffraction is increased due to the increase in the number of layers, while at the edge (iv), higher diffraction is as a result of the presence of heavier atoms, presumably two oxygen atoms on top of each other to form COOH group.

FIG. 11 shows reference data applied in the current modelling of a data farm. The Cₚ of pure graphene is about 7-20 J/kmol.

FIG. 12 shows a thermal analysis report for 0.25 wt. % edge functionalised graphene in 70:30 water:ethylene glycol.

FIG. 13 shows a thermal analysis report for 0.5 wt. % edge functionalised graphene in 70:30 water:ethylene glycol.

FIG. 14 shows a thermal analysis report for 0.75 wt. % edge functionalised graphene in 70:30 water:ethylene glycol.

FIG. 15 shows the design basis for the data centre cooling modelling performed by the Applicant. There were 42 servers/rack; 100 racks; power input of 12 kW/rack; 4200 servers; 287 W heat generated per server; and 1205 W total heat generated by each server rack.

FIG. 16 shows the thermal performance of the edge functionalised graphene thermal fluid at concentrations from 0 to 5 wt. %. From the data, it can be seen that conductive component edge functionalised graphene plays a critical role in increasing heat rejection and thermal performance.

FIG. 17A maps the increase (%) in thermal coefficient against the estimated decrease in thermal area (%) from edge functionalised graphene concentrations between about 0 and 5 wt. %.

FIG. 17B tests the assumptions made in FIG. 17A. It plots calculated Cₚ versus the Cₚ of the thermal test results.

FIG. 18 shows cooling pump capacity demand at flow rates from about 100 m³/h to about 225 m³/h.

FIG. 19 shows enthalpy versus temperature consideration in modelling the cooling tower of the present simulation.

FIG. 20 shows a high level cooling tower area estimation across edge functionalised graphene concentrations of 0.25, 0.5, 0.75, 1, 1.25, 1.5, 2 and 5 wt. %.

FIG. 21 shows the calculations performed in modelling a quantity of 4000 servers and the allocation of power output, which was calculated to be 36.58% for the servers/mainframes.

FIG. 22 shows a similar power allocation to FIG. 21, against which the annual energy saving data were calculated.

FIG. 23 shows the expected reduced power consumption using the edge functionalised graphene thermal fluid of the present invention. It can be clearly seen at concentrations between about 0.25 and about 1 wt. % that the percentage saving is most pronounced. These data were obtained using edge functionalised graphene in a dispersion medium of 70:30 water/ethylene glycol.

### DETAILED DESCRIPTION OF A PREFERRED EMBODIMENT

The present invention provides a composition for use as a thermal fluid, the composition comprising:
a) an amount of a dispersible graphene platelet including a base layer of graphene; at least one discontinuous graphene layer stacked on the base layer; wherein the at least one discontinuous layer has a smaller surface area than the base layer; and wherein the edge regions of the base layer and the at least one discontinuous layer are at least partially functionalised; and
b) a dispersion medium comprising an amount of water.

The amount of the dispersible graphene platelet is between about 0.1 and about 6 wt % of the composition, but is shown through empirically modelled data to be most optimally between about 0.25 and about 1 wt. %.

The dispersion medium is preferably water, or may be water and ethylene or propylene glycol in an approximate volume ration of about 70:30.

As described above, one or more co-solvents may be added to the composition. Such co-solvents comprise glycols, alcohols, surfactants, dyes, defoamers, acids, bases and the like.

Thermal Analysis Labs (TAL) conducted calorimetry and thermal conductivity analyses of nine compositions of edge functionalised graphene in 70:30 water/ethylene glycol as described above in respect of the dispersion medium. The data are provided in Table 1, below.

TABLE 1
Calorimetry and thermal conductivity report data

| | | | | | Thermal | |
|---|---|---|---|---|---|---|
| | Thermal effusivity | | | Specific heat | conductivity | |
| Sample | (Ws^{1/2}m⁻²K⁻¹) | | Density | capacity | (W/mK) | |
| (EFG %) | Measured | RSD | (kg/m³) | (J/kgK) | Calculated | RSD |
| 4-1 (0%) | 1306 | 0.4% | 1020 | 3840 | 0.431 | 0.9% |
| 5-1 (0.25%) | 1018 | 0.3% | 1030 | 2780 | 0.365 | 0.5% |
| 5-2 (0.5%) | 1492 | 0.5% | 1030 | 3450 | 0.633 | 1.0% |
| 5-3 (0.75%) | 1591 | 0.3% | 1030 | 3770 | 0.658 | 0.5% |
| 5-4 (1%) | 1855 | 0.2% | 1030 | 3720 | 0.907 | 0.5% |
| 5-5 (1.25%) | 1921 | 0.3% | 1030 | 3580 | 1.010 | 0.6% |
| 5-6 (1.5%) | 2014 | 1.2% | 1030 | 3580 | 1.111 | 2.4% |
| 5-7 (2%) | 2130 | 0.3% | 1030 | 3600 | 1.236 | 0.7% |
| 5-8 (5%) | 2298 | 0.4% | 1030 | 3580 | 1.446 | 0.8% |

* EFG = edge functionalised graphene

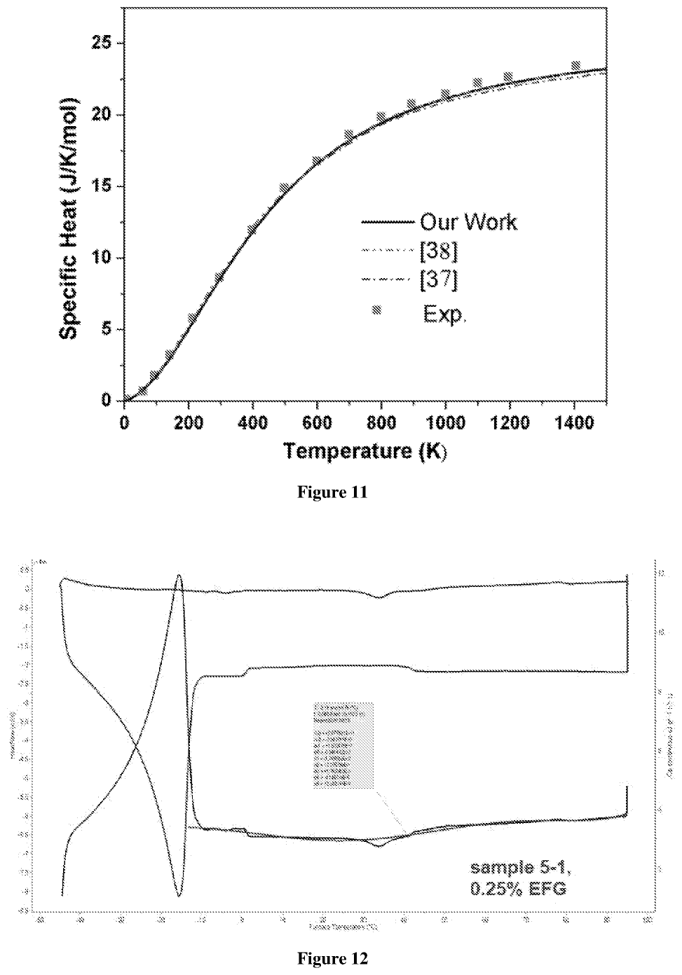

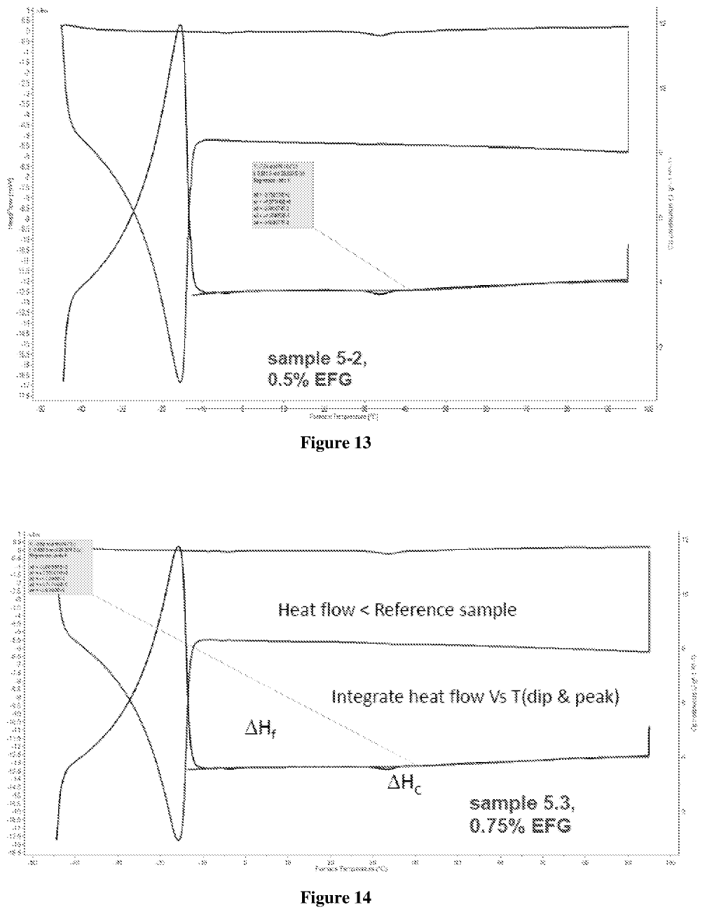

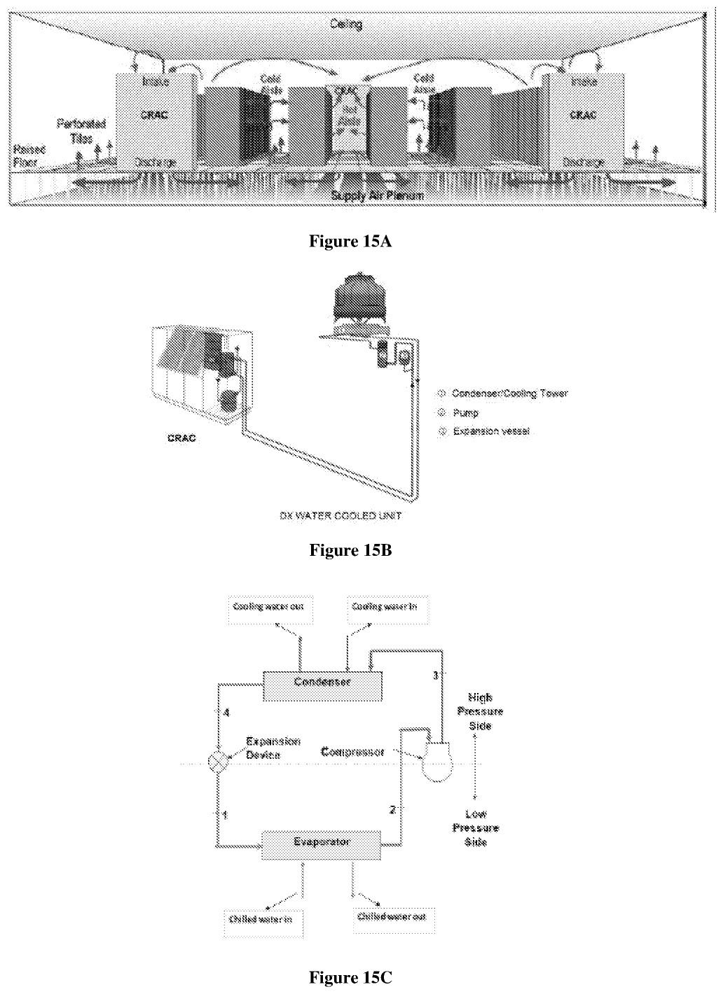

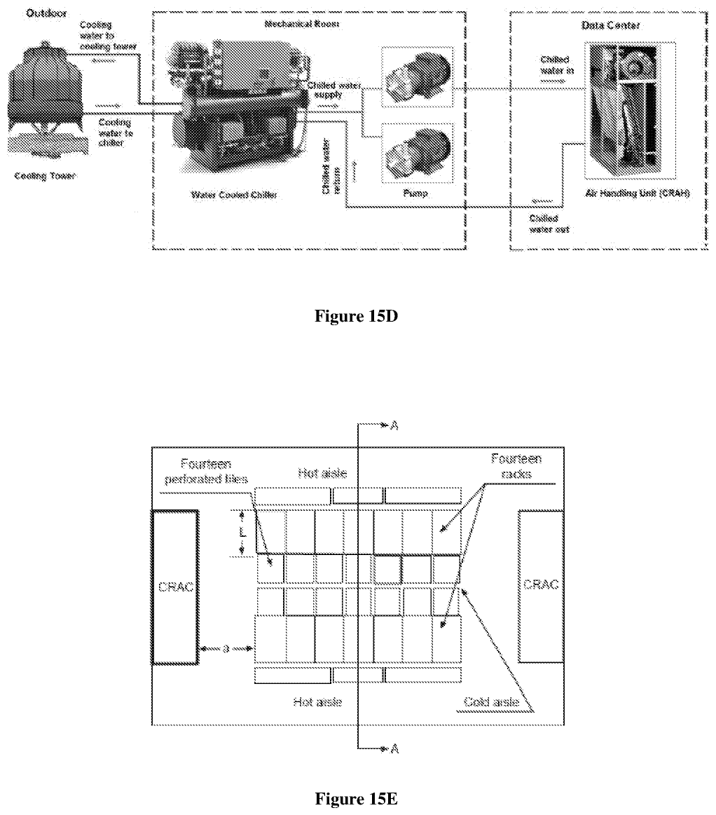

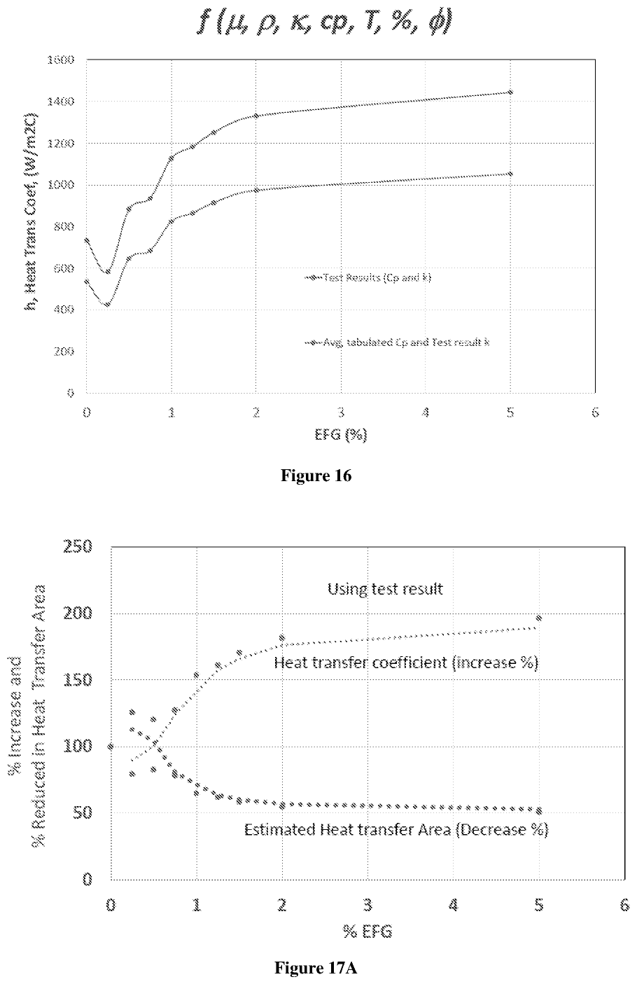

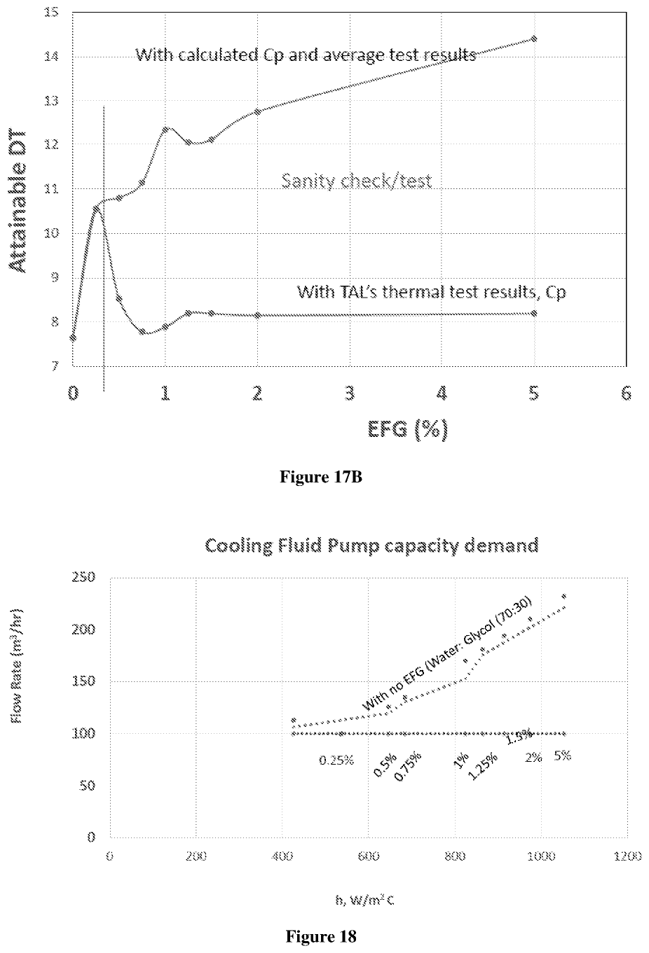

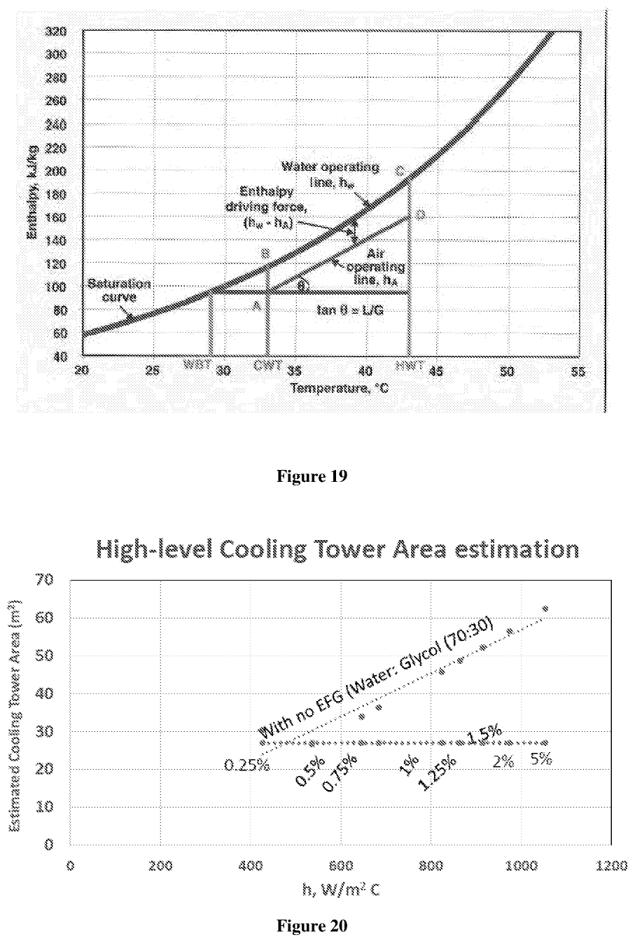

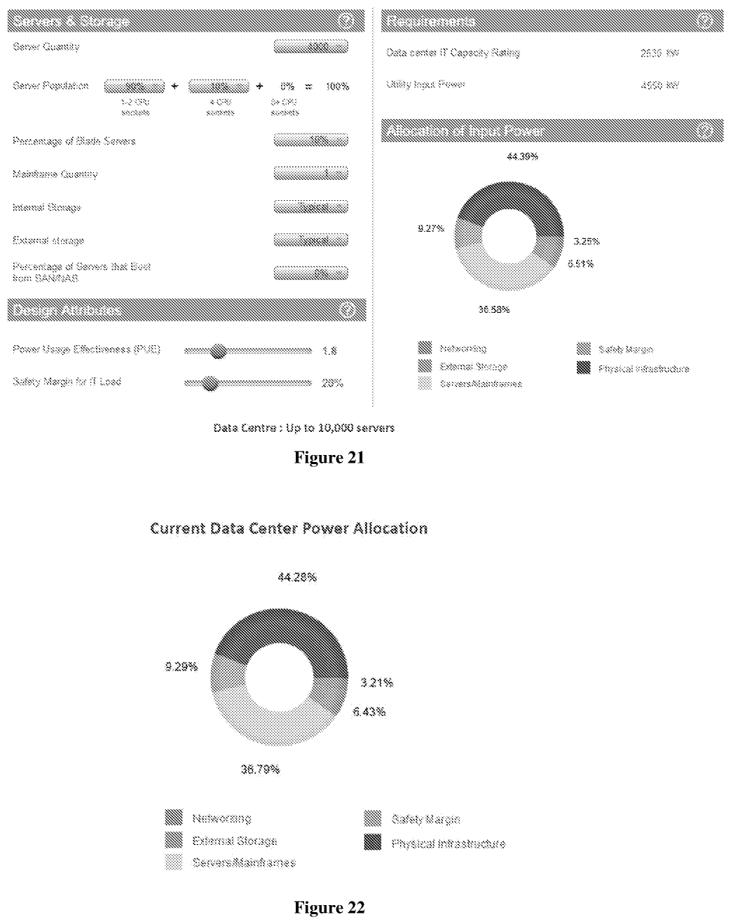

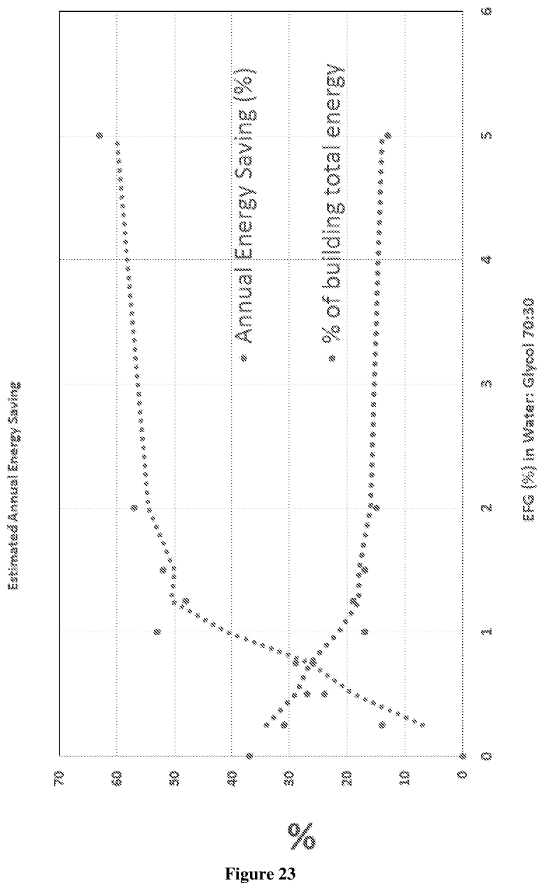

The data obtained above were used to model the potential energy savings applicable to a data centre, as shown in FIGS. 11 to 23 appended hereto. In particular, FIG. 23 demonstrates that annual energy savings between about 10 and about 50% may be achievable using thermal fluids as described in the present invention, in concentrations ranging from about 0.25 to about 1 wt. %. Energy savings beyond about 1 wt. % edge functionalised graphene are less pronounced, suggesting that the optimal concentration of edge functionalised graphene in 70:30 water/ethylene glycol is between about 0.2 and about 1 wt. %.

Based upon the data, several conclusions may be reached: Thermal performance increases with an increase in edge functionalised graphene composition; it probable that the optimum composition ranges between 0.25 and <1 wt. %; the edge functionalised graphene thermal fluid offers increased heat rejection in the range of the cooling tower, thereby lowering the energy usage of a data centre; estimated annual energy reduction ranges from ˜15% to ˜30% (at edge functionalised graphene concentrations from 0.25 to 0.75 wt. %); and of most commercial significance, edge functionalised graphene may allow existing and future data centre cooling systems to achieve a significant improvement in heat rejection performance, energy saving and cost reduction.

The dispersible graphene platelet has a structure containing a base layer of graphene at a micron scale. On the surface of this base layer are irregular nanometer sized graphene layers which may be stacked as high as seven to nine layers above the base layer. Otherwise stated, the structure comprises a base layer of graphene on which at least one discontinuous layer of graphene is stacked, with each layer of graphene above the base layer having a smaller surface area than the layer it is stacked upon. The edges of the base layer and the discontinuous layers stacked upon it are all at least partially functionalised, providing a structure with graphene-like properties owing to the base layer and improved dispersibility owing to the increased amount of functionalised groups on each platelet.

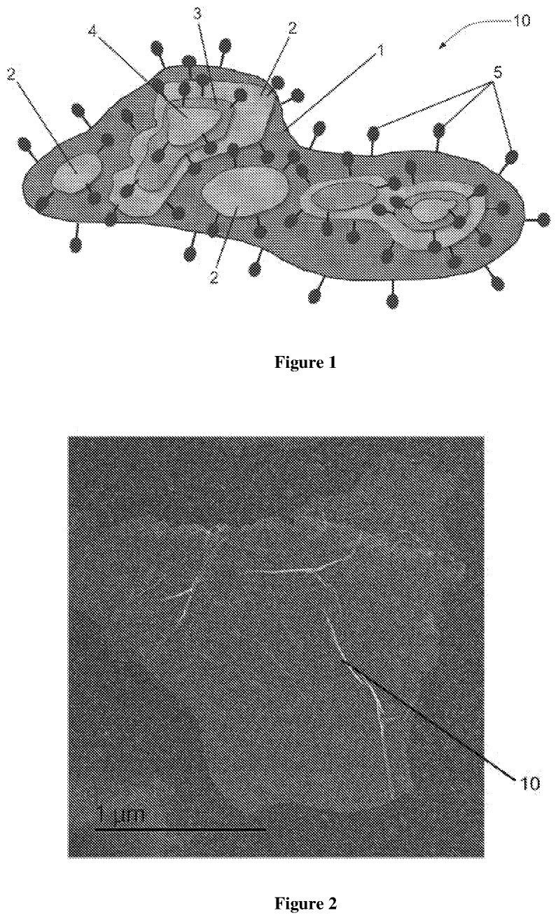

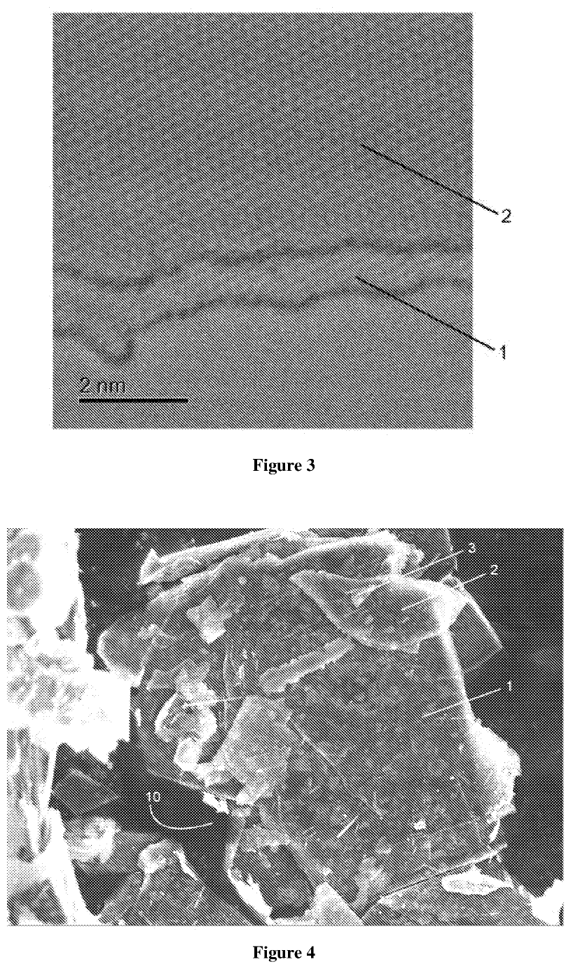

FIGS. 1 and 2-4 show a schematic view and microscopy images respectively of a dispersible graphene platelet 10. The base graphene layer 1 is sized at a micron level, and features functionalised groups 5 such as hydroxyl or carboxyl acids around its edges. Platelet 10 further includes a discontinuous graphene layer 2 stacked on the surface of base layer 1. Further discontinuous graphene layers 3 and 4 are stacked on top of layer 2, the surface area of each discontinuous layer may be smaller relative to the layer below it. The edges of each discontinuous layer also feature a degree of functionalisation in the form of functionalised groups 5.

In a preferred embodiment, RuO₄ may be used as the oxidant for functionalising the edges of the graphene platelets. RuO₄ is suitable owing to its strong but selective oxidation effects, allowing the partial conversion of the outermost rings of the graphene structure to carboxylic acids or phenols while leaving the inner structure unmodified. RuO₄ can be provided to the graphene or graphite via the reaction of RuCl₃ and NaIO₄ in solution.

In another preferred embodiment, the graphite used to produce the dispersible graphene platelets may be first thermally expanded to increase the interlayer spacing prior to being placed in solution. This may, in one non-limiting example, be carried out at temperatures between 700-1000° C. Graphite treated in this way is commonly referred to as expanded graphite.

The produced graphene platelet dispersion may be used to produce electrically conducting materials. For instance, it may be desirable to use these platelets to fabricate electrodes for electrochemical processes using a mixture of a dispersion of platelets with a binder such as Nafion or PVDF and coating the resultant mixture onto an electrode surface. An electrode produced in this manner could then be used in a battery or in electrochemical processes such as CO₂ reduction.

In some embodiments, the produced graphene platelets can be further functionalised by binding of metal ions to either the functionalised edges or the surface of the platelet. In some preferred embodiments, the metal ions are selected from iron, copper, cobalt and tin.

The present disclosure will become better understood from the following example of a non-limiting embodiment of a method for producing the aforementioned graphene platelets.

In a first experiment, 100 mg of graphene with 99.9999% purity was suspended in a solution containing 2 mL of MeCN, 2 mL of EtOAc, and 2 mL of water. 222 mg (0.125 eq) of NaIO₄ and 4 mg (0.002 eq) of RuCl₃·xH₂O. The resulting mixture was cooled using an ice bath and homogenized at 20000 rpm for 1 hour. Following this, the mixture was ultrasonicated for 2 hours, filtered, and washed with water and 1 M HCl until the filtrate was colourless. The filtrate was then washed with water until the filtrate was neutral. The filtrate was then freeze dried to produce a black powder containing edge functionalised graphene platelets.

In a second experiment, graphite (20 g, 1.67 mol) was suspended in MeCN (400 mL), EtOAc (400 mL) and water (600 mL). NaIO₄ (71.2 g, 333 mmol) and RuCl₃·xH₂O (820 mg, 3.4 mmol, ˜0.2 mol %) were added and the resulting mixture was cooled in an ice bath and homogenized (˜20000 rpm) for 1 hour. The homogenizer was then removed and the mixture was ultrasonicated for 2 hours. The suspension was filtered, then the filtered solid was washed with water (100 mL) to remove excess, 1 M HCl until the filtrate was colourless, then again with water until the filtrate was neutral. The resulting solid could be suspended in water and freeze dried or washed with ethanol and dried in vacuo to yield the product as a black powder.

It will be understood that while the ruthenium tetroxide was formed in these experiments by sodium periodate and ruthenium chloride, other oxidants such as sodium hypochlorite may be used instead.

It has also been found that a longer lasting dispersion can be achieved by removing non-dispersible particles. This may be carried out by an additional process on the dried powder, comprising sonicating a dispersion of the dried powder in water for up to 30 minutes and allowing the resulting dispersion to either settle for up to 48 hours or centrifuging the dispersion. The dispersion supernatant can then be decanted to remove the settled particles, and then the supernatant filtered to obtain the graphene powder. This powder can then be washed with an organic solvent such as ethanol or acetone and dried in vacuo or freeze dried.

A number of experiments were carried out to characterize the platelets and verify the presence of functional groups at the edges of each layer. These are described below.

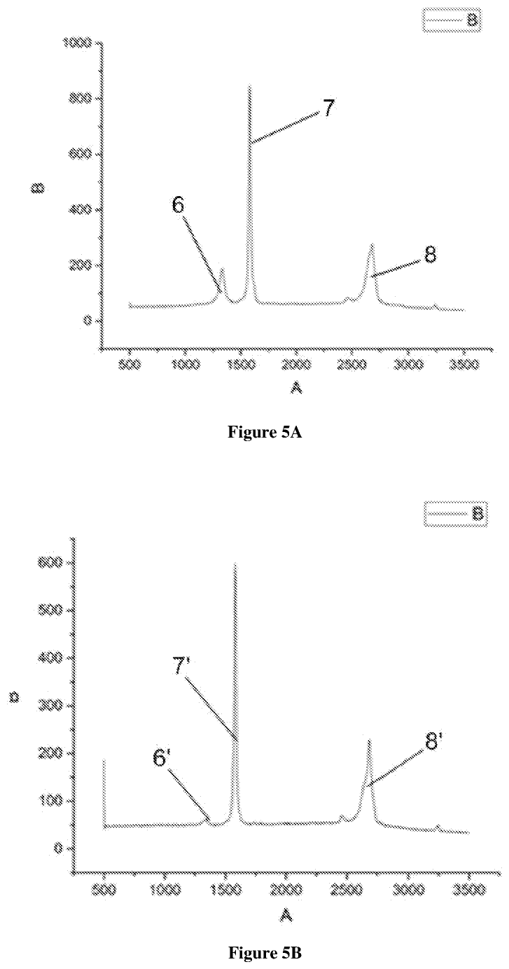

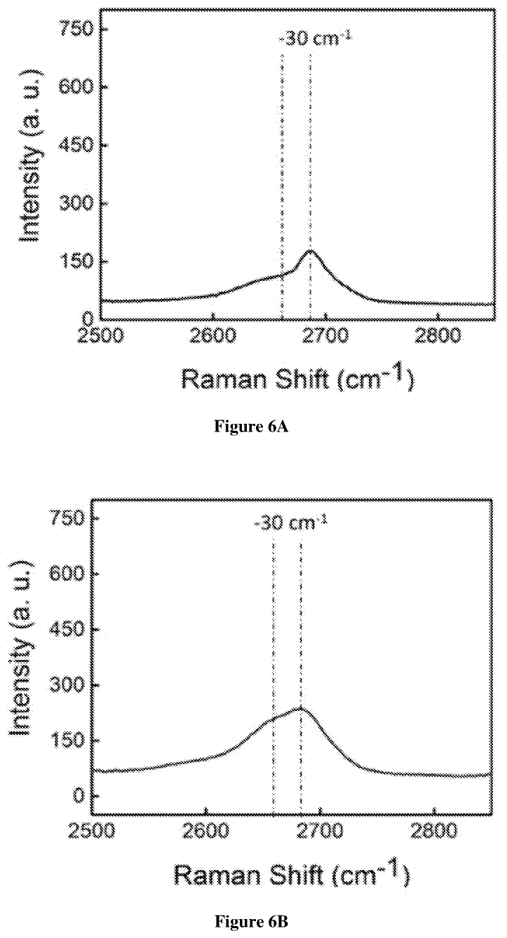

Raman spectroscopy was used to compare the chemical structure of the produced graphene platelets to that of bulk graphite. Referring to FIGS. 5A and 5B, the Raman spectra of produced graphene platelets and 99.9999% pure graphite are shown respectively. Both spectra show a D band 6, 6′, a G band 7, 7′, and a 2D band 8, 8′. Graphene structures produced by reduced graphene oxide which typically show D bands larger than the G band which is not the case for the produced platelets. This suggests that the platelets are substantially graphene. Referring to FIGS. 6A and 6B, analysis of the 2D Raman bands of the edge and basal planes respectively of the graphene plates allowed the determination of a thickness metric M, which can be used to determine the number of monolayers per graphene flake N_{G} according to the equation N_{G}=10^{0.84M+0.45M}^{²} This confirmed that there were 2 layers at the graphene platelet edges and up to 6 layers on the basal plane.

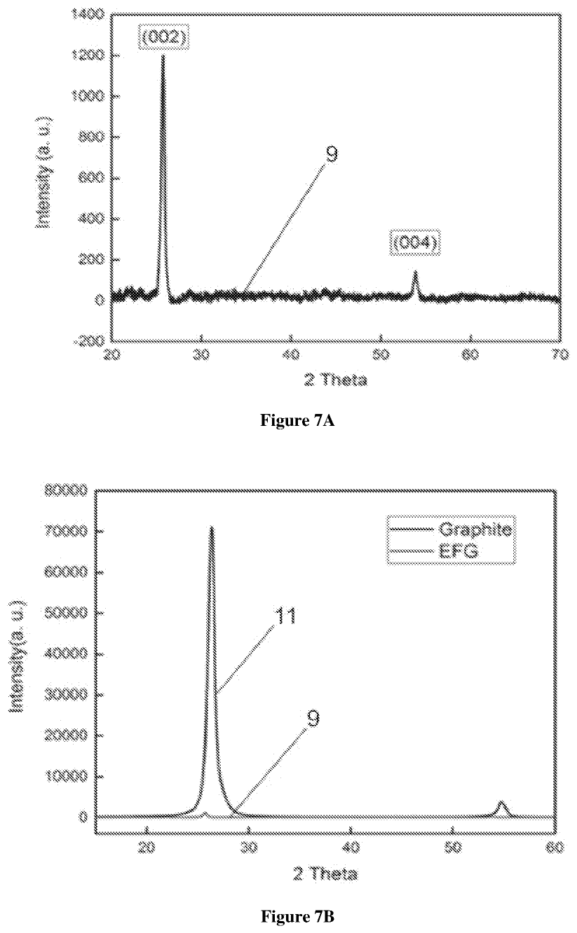

Referring to FIGS. 7A and 7B, this is further backed up by the results of x-ray diffraction, where the graphene platelet spectrum 9 is substantially in line with the spectrum of graphite 11. The diminished intensity is expected as XRD provides a measure of crystallinity and graphite, consisting of numerous graphene layers necessarily has a far greater degree of crystallinity than graphene platelets which only have a few layers. The slight shift in the platelet spectrum 9 compared to graphite 11 is attributed to the functional groups at the edges increasing the interlayer distance.

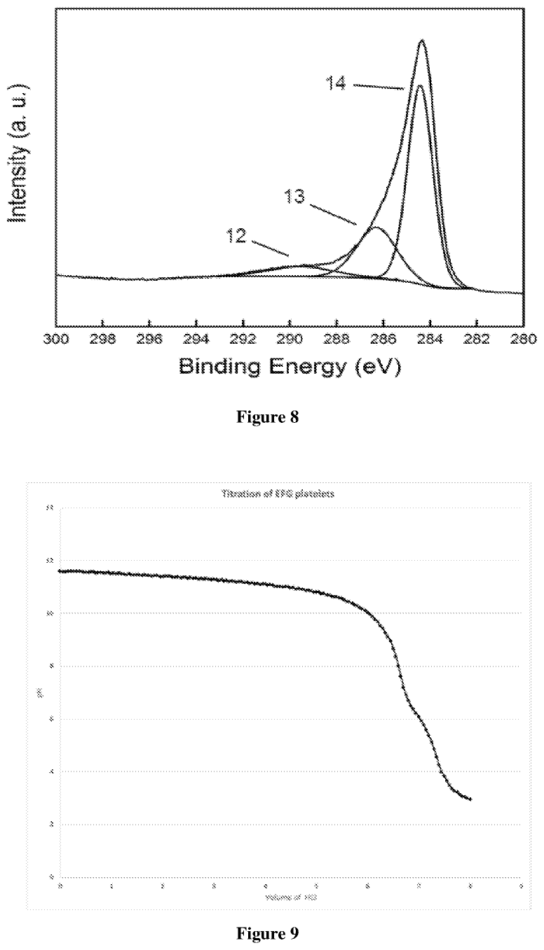

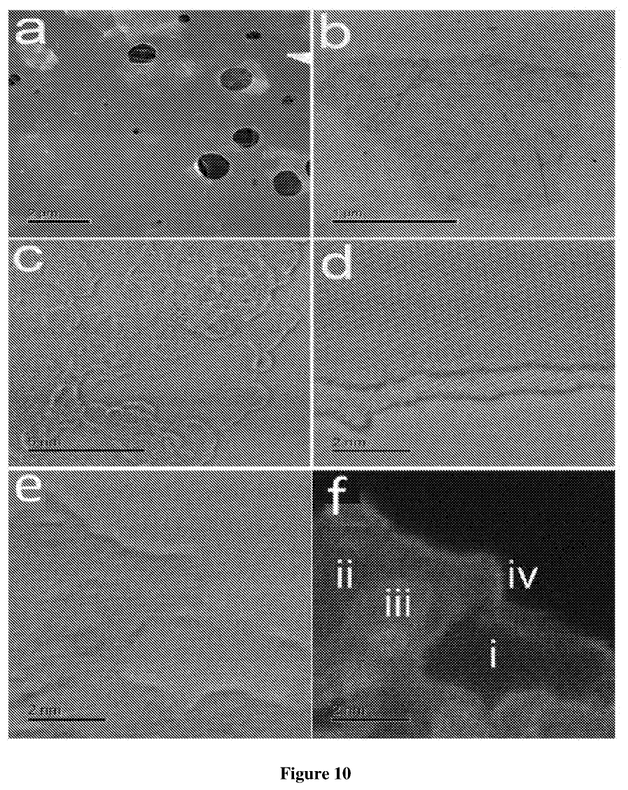

The presence of the functional groups was investigated using X-ray photoelectron spectroscopy. This showed a composition of 94% C and around 6% O similar again to graphite. The XPS spectra as shown in FIG. 8 shows the presence of 3 different types of C atoms, aromatic C at 284.5 eV (14 in FIG. 8), phenolic C at 286.3 eV (13 in FIG. 8) and carboxyl C at 289.8 eV (12 in FIG. 8), suggesting the presence of carboxylic acid and phenol groups. Thermogravimetric analysis was conducted to calculate a carboxylic acid content of 0.15 mEq/g. High angle annular dark field (HAADF) scanning transmission electron microscopy showed bright edges attributed to the presence of oxygen atoms at these locations, suggesting successful edge functionalisation of the graphene platelets. The presence of both carboxyl and phenolic groups was further supported by titration of a dispersion of the edge functionalized graphene platelets in 0.1 M NaOH by 0.1 M HCl, as shown in FIG. 9 which shows two pKa values at pH=4.2 and 8.0, attributable to the carboxyl and phenolic groups, respectively.

With the structure of the platelets established, experiments were carried out to measure the dispersibility and conductivity of the platelets, as well as their ability to be fabricated into polymer composites.

The edge functionalised graphene platelets were found to allow suspensions in water at concentrations of up to 700 mg/mL in contrast to the 0.55 mg/mL previously achieved by previous methods. Suspensions of up to 10 mg/mL edge functionalised graphene in water were found to be stable for at least 3 months. At suspensions over 10 mg/mL, settling of the platelets was observed in solution, however redispersion could be achieved with brief shaking of the solution. Suspensions of 100 mg/mL have been found to be stable in water for at least 6 hours. Suspensions of 50 mg/mL have been found to be stable in organic solvents such as toluene, ethanol, NMP and DMF for at least 6 hours. Improved dispersion was also found in other solvents including IPA, MeOH, CH₂Cl₂, DMF, and THF, and suggests that the platelets may also have high dispersion in other solvents not explicitly mentioned.

For suspensions with a relatively high proportions of graphene platelets to solvent, the nature of the resultant solution may change. Suspensions of the edge functionalised graphene platelets with more than 25 wgt % edge functionalised graphene in water have been found to form a paste, while suspensions with more than 35 wgt % edge functionalised graphene in water have been found to form a moldable dough. The ability of the resultant dough to be molded allows the forming of almost any shape from the material. Pastes have been observed in 250 mg/mL in water, organic solvents, and ionic liquids. Doughs have been observed in 350-700 mg/mL in water, organic solvents, and ionic liquids.

The edge functionalised graphene platelets were formed into free-standing papers using vacuum filtration and the conductivity measured by 4 point probe conductivity measurements. The free-standing paper was found to have a highly desirable electrical conductivity of 900 S/cm.

Alternatively, the produced platelet dispersions can be used to fabricate composite materials, for example using a polymer such as alginate, chitosan, PVA, PEG, PU, PEI, PVDF or PEDOT PSS. In a first test experiment, 50 mg of platelets and 100 mg of polyvinyl alcohol (PVA) were stirred in 150 mL of water at 60° C. for between 6 and 8 hours until it was concentrated to 10-15 mL. Drop casting was then used to produce free-standing films of a PVA-graphene platelet composite. In another composite fabrication proof of concept test, a dispersion of 70% graphene platelets and 30% chitosan in water were 3D extrusion printed to form a scaffold.

The produced platelet dispersions were also used to fabricate metal functionalised graphene platelets. A proof of concept test was carried out comprising mixing a 0.1 mg/mL solution of iron chloride (FeCl₃) with a 1 mg/mL graphene platelet dispersion. The mixture was then stirred for 30 minutes at room temperature before being centrifuged, washed with water to remove excess iron chloride, then freeze dried. This successfully resulted in Fe-functionalised graphene platelets as measured by XPS and SEM imagery, with XPS showing substitutional iron doping at the surface at 0.4 at. %. Fe-functionalised graphene platelets showed magnetic behavior.

Further functionalisation was achieved by annealing the Fe-functionalised platelets at 750° C. under N₂ gas for 1 hour, resulting in a dispersion of iron/iron oxide nanoparticles across the platelet surface. Similar tests, using copper chloride and tin chloride in place of iron chloride resulted in copper/copper oxide and tin/tin oxide nanoparticles being bound to the platelets respectively.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

### INDUSTRIAL APPLICABILITY

As demonstrated herein, the edge functionalised graphene thermal fluids of the present inventions may allow existing and future data centre cooling systems to achieve a significant improvement in heat rejection performance, energy saving and cost reduction.

1. A composition for use as a thermal fluid, the composition comprising:
a) an amount of a dispersible graphene platelet including a base layer of graphene;
at least one discontinuous graphene layer stacked on the base layer; wherein the at least one discontinuous layer has a smaller surface area than the base layer; and wherein the edge regions of the base layer and the at least one discontinuous layer are at least partially functionalised; and
b) a dispersion medium comprising an amount of water.

2. The composition according to claim 1, wherein the amount of the dispersible graphene platelet is between about 0.1 and about 6 wt % of the composition.

3. The composition according to claim 1, wherein the dispersion medium further comprises one or more co-solvents selected from glycols, alcohols, surfactants, dyes, defoamers, acids, bases and the like.

4. The composition according to claim 3, wherein the dispersion medium comprises water and the one or more co-solvents in an approximate 50:50 to 80:20 ratio by weight.

5. The composition according to claim 1, wherein the platelet is able to form a stable dispersion in water at concentrations up to 700 mg/mL.

6. The composition according to claim 1, wherein the electrical conductivity of the platelet is approximately 900 S/cm.

7. The composition according to claim 1, wherein the platelet is further functionalised by the addition of metal ions selected from Fe, Cu, Co, and Sn to at least one of the functionalised edges or the surface.

8. A composition for use as a thermal fluid, the composition comprising:
a) an amount of a polymer-matrix composite material comprising a polymer and a dispersible graphene platelet as defined according to claim 1; and
b) a dispersion medium comprising an amount of water.

9. (canceled)

10. (canceled)

11. (canceled)

12. (canceled)

13. (canceled)

14. (canceled)

15. (canceled)

16. The composition according to claim 8, wherein the polymer is selected from alginate, chitosan, PVA, PEG, PU, PEI, PVDF, PDMS or PEDOT PSS.

17. A method for producing a composition for use as a thermal fluid, the method comprising the steps of:
a) forming an amount of a dispersible graphene platelet as defined according to claim 1 by suspending graphite or graphene in a solution containing an organic nitrile (such as acetonitrile), an ester (such as ethyl acetate) and water; and reacting the solution containing suspended graphite or graphene with an oxidant (such as ruthenium tetroxide) to at least partially functionalise edge regions of the graphite or graphene;
b) forming a dispersion medium comprising an amount of water;
c) mixing the amount of the dispersible graphene platelet with the amount of water, thereby to create a substantially homogeneous composition.

18. (canceled)

19. (canceled)

20. (canceled)

21. The method according to claim 17, wherein the dried powder is dispersed in water and sonicated for up to 30 minutes, and a resulting mixture is allowed to settle for up to 48 hours to produce a solid and a supernatant, and decanting and filtering the supernatant to produce a graphene powder.

22. (canceled)

23. The method according to claim 17, wherein the oxidant is ruthenium tetroxide provided via the reaction of sodium periodate with ruthenium chloride added to the solution containing suspended graphene or graphite.

24. The method according to claim 17, wherein the graphene or graphite is provided in the form of expanded graphite with an increased interlayer spacing.

25. The method according to claim 21, wherein the graphene powder is then dispersed in a solution containing metal ions selected from Fe, Cu, Co, and Sn to bind metal ions to at least one of a surface or a functionalised edge of the platelet.

26. A method for producing a composition for use as a thermal fluid, the method comprising the steps of:
a) forming an amount of a polymer-matrix composite material comprising a polymer and a dispersible graphene as defined according to claim 1; and
forming a dispersion medium comprising an amount of water;
c) mixing the amount of the dispersible graphene platelet with the amount of water, thereby to create a substantially homogeneous composition.

27-35. (canceled)
